(19) United States
(12) Patent Application Publication
(10) Pub. No.: US 2016/0110283 A1
(43) Pub. Date: Apr. 21, 2016

(54) ON-DEMAND EXPANSION OF SYNCHRONIZATION PRIMITIVES

(71) Applicant: Microsoft Corporation, Redmond, WA (US)

(72) Inventors: Mehmet Iyigun, Kirkland, WA (US); Yevgeniy Bak, Redmond, WA (US); Christopher Peter Kleynhans, Bellevue, WA (US); Syed Aunn Hasan Raza, Bellevue, WA (US); Thomas James Ootjers, Kirkland, WA (US); Neeraj Kumar Singh, Seattle, WA (US)

(21) Appl. No.: 14/518,995

(22) Filed: Oct. 20, 2014

(51) Int. Cl. G06F 12/08

(52) U.S. Cl. CPC G06F 12/084; G06F 12/0842; G06F 2212/281

(57) ABSTRACT

Disclosed are techniques and systems for providing on-demand expansion of a non-cache-aware synchronization primitive to a cache-aware form. The expansion may occur on-demand when it becomes necessary to do so for performance and throughput purposes. Expansion of the synchronization primitive may be based at least in part on a level of cache-line contention resulting from operations on the non-cache-aware synchronization primitive. The synchronization primitive in the expanded (cache-aware) form may be represented by a data structure that allocates individual cache lines to respective processors of a multiprocessor system in which the synchronization primitive is implemented. Once expanded, the cache-aware synchronization primitive may be contracted to its non-cache-aware form.

### BACKGROUND

Improving performance of multiprocessor computer systems is at the forefront of computer architecture and operating system design. To this end, operating systems are typically designed to support multiprocessor systems having processes or threads that are able to concurrently run on separate processors to access objects or data structures in shared memory (e.g., main memory).

In order to support such a multiprocessor system, synchronization primitives are typically employed by the operating system to avoid race conditions. Race conditions occur when multiple threads access and manipulate the same object or data structure at the same time, which may result in flawed data. Synchronization primitives, in general terms, may enforce a policy that prevents a thread from exclusively accessing an object before another thread is finished accessing the object. Enforcement of this policy synchronizes the threads' access to the object by managing concurrent interactions of the threads, thus avoiding race conditions.

When a given thread acquires a synchronization primitive in order to access an object in shared memory, the thread may perform what is called an “interlocked operation” that typically involves modifying data. An interlocked operation is an atomic instruction that requires a cache line of shared memory to be “owned” by the processor that is executing the thread. In other words, a thread that is performing an interlocked operation on data that currently resides in another processor's cache must first bring the cache line to local cache memory of the processor on which the thread is executing in order to operate on the data.

When a large number of processors (e.g., hundreds of processors) are concurrently executing threads that are performing interlocked operations (e.g., when the threads are attempting to acquire a synchronization primitive in order to access data), a phenomenon called “cache-line contention” occurs. Cache-line contention involves “pinging” or “bouncing” a cache line back and forth between different processors in an attempt by each processor to own the cache line. Cache-line contention is very expensive in terms of throughput (i.e., the number of tasks processed in a given unit of time) of a multiprocessor system because the processors end up spending a good portion of their time bouncing cache lines back and forth instead of processing tasks. As a result, such multiprocessor systems are not scalable (i.e., cache-line contention worsens as more processors are added, which negatively impacts the throughput of the system).

One suitable approach for mitigating cache-line contention in shared data structures is to implement scalable (“cache-aware”) synchronization primitives that allocate cache lines of shared memory on a per-processor or per-node basis. By allocating a cache line for each processor/node, cache-line contention can be mitigated. However, systems with a large number of processors require high memory usage to maintain such cache-aware synchronization primitives relative to the small amount of memory that is used for non-cache-aware synchronization primitives. As a result, developers are forced to choose between scalability improvements by using cache-aware synchronization primitives or memory benefits by using non-cache-aware synchronization primitives.

### SUMMARY

Described herein are techniques and systems for providing on-demand expansion of a non-cache-aware synchronization primitive to a cache-aware form. Notwithstanding the scalability benefits provided by cache-aware synchronization primitives, it is recognized that cache-line contention is an intermittent occurrence. Thus, cache-aware synchronization primitives may, at times, occupy a valuable memory footprint when they are not actually needed for increasing throughput. At the same time, it is also recognized that a multiprocessor system with many (e.g., hundreds) of processors running in parallel is likely to perform poorly without cache-aware synchronization primitives that work to mitigate cache-line contention, even if the contention arises intermittently.

In some embodiments, a non-cache-aware synchronization primitive is provided for a multiprocessor system, wherein the non-cache-aware synchronization is configured to expand to a cache-aware form when it is necessary to do so for performance and throughput purposes. In order to determine when it is necessary to expand the non-cache-aware synchronization primitive, the system may determine a level of cache-line contention resulting from operations on the non-cache-aware synchronization primitive. In other words, a “cost” of the operations on the non-cache-aware synchronization primitive may be measured in a quantifiable manner, and that measured cost may be compared to a threshold that, if exceeded, triggers the expansion of the non-cache-aware synchronization primitive to a cache-aware form, which results in a synchronization primitive with per-processor/node state that allocates individual cache lines to respective processors of the multiprocessor computer system.

In some embodiments, the synchronization primitive, once expanded, may be contracted or reverted to the non-cache-aware form. Such contraction may occur after a period of time has lapsed since the synchronization primitive was expanded and/or after determining that cache-line contention has subsided (i.e., dropped to a level where the cache-aware synchronization primitive is no longer needed).

The techniques and systems described herein provide scalability due to the availability of expandable synchronization primitives that, when expanded, provide high performance and throughput. These expandable synchronization primitives are also low in memory cost due to the limited number of synchronization primitives that may be expanded at any given time. The benefits afforded by the embodiments herein allow for implementation of expandable synchronization primitives with highly multiplicative data structures (e.g., data structures having thousands upon thousands of files, handles, registry keys, etc.). Thus, the techniques and systems described herein are likely to result in significant improvements in performance and throughput while being cheap from a memory cost standpoint.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicates similar or identical items.

FIG. 1 illustrates an example multiprocessor computer system for implementing expandable synchronization primitives.

FIG. 2 is a diagram illustrating example data structures that are representative of an expandable synchronization primitive.

FIG. 3 is a flow diagram of an illustrative process for expanding a non-cache-aware synchronization primitive on-demand.

FIG. 4 is a flow diagram of an illustrative process for determining whether cache-line contention triggers expansion of a non-cache-aware synchronization primitive.

FIG. 5 is a flow diagram of a more detailed illustrative process for expanding a non-cache-aware synchronization primitive.

FIG. 6 is a flow diagram of an illustrative process for contracting a cache-aware synchronization primitive.

### DETAILED DESCRIPTION

Embodiments of the present disclosure are directed to, among other things, techniques and systems for providing on-demand expansion of a non-cache-aware synchronization primitive to a cache-aware form. Although many of the examples presented herein are described in terms of a lock, the embodiments disclosed herein may be implemented with any suitable type of synchronization primitive, including, without limitation, a rundown reference, a spinlock, a mutex, and so on.

The techniques and systems described herein may be implemented in a number of ways. Example implementations are provided below with reference to the following figures.

### Example Multiprocessor Computer System

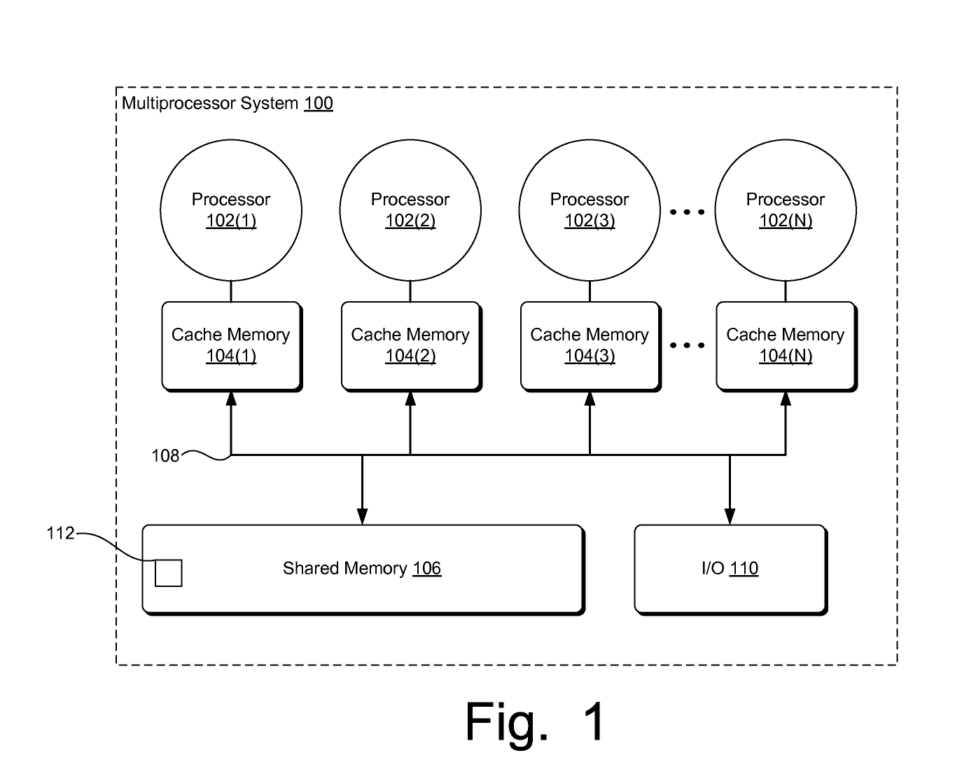

FIG. 1 illustrates an example multiprocessor computer system 100 for implementing expandable synchronization primitives. For example, the multiprocessor system 100 may represent one or more computing machines, including, without limitation, one or more servers, one or more data center systems, one or more personal computers, or any other suitable computing device(s), whether the computing device is mobile or situated. The system 100 is merely one example multiprocessor system to implement the techniques described herein such that the techniques described herein are not limited to performance using the system of FIG. 1.

The multiprocessor system 100 may include a plurality of processors 102(1), 102(2), 102(3), . . . , 102(N) (collectively 102), which may represent any suitable type of execution unit, such as a central processing unit (CPU), a core, and/or a node, depending on the implementation details of the multiprocessor system 100. For example, any individual processor 102 may represent a single CPU, a node having multiple processors or cores configured to execute separate threads, or any other suitable processor arrangement. Individual ones of the processors 102 may each have an associated local cache memory 104(1), 104(2), 104(3), . . . , 104(N) (collectively 104). The cache memory 104 may contain one or more cache levels (e.g., L1, L2, etc.) and may function as an intermediary that is placed between the processors 102 and a shared memory 106 (e.g., main memory, or system memory) of the multiprocessor system 100 to provide the functionality of the shared memory 106 at the speed of the individual processors 102.

The shared memory 106, as its name implies, may be shared between the processor 102-cache memory 104 pairs. Accordingly, a bus 108 may connect the processors 102 and cache memories 104 to the shared memory 106. In some embodiments, the bus 108 may represent an interconnection network, such as those typically implemented in non-uniform memory access (NUMA) systems. Depending on the exact configuration, the shared memory 106 may be volatile (e.g., random access memory (RAM)), non-volatile (e.g., read only memory (ROM), flash memory, etc.), or some combination of the two. Moreover, the shared memory 106 may be physically centralized relative to the processors 102 and cache memories 104, or the shared memory 106 may be physically distributed among the plurality of processors 102, to be shared as one logical address space by the processors 102. Accordingly, access times from each processor 102 to the shared memory 106 may be uniform, or access times from each processor 102 to the shared memory may vary, depending on the configuration. The multiprocessor system may further include an input/output (I/O) system 110 including I/O devices and media.

The multiprocessor system 100 may also include additional data storage devices (removable and/or non-removable) such as, for example, magnetic disks, optical disks, or tape, which are all examples of computer storage media. The shared memory 106 is another examples of computer storage media. Computer storage media may include volatile and nonvolatile, removable and non-removable media implemented in any method or technology for storage of information, such as computer readable instructions, data structures, program modules, or other data. Computer storage media includes, but is not limited to, RAM, ROM, electrically erasable programmable read-only memory (EEPROM), flash memory or other memory technology, compact disk read-only memory (CD-ROM), digital versatile disks (DVD), or other optical storage, magnetic cassettes, magnetic tape, magnetic disk storage or other magnetic storage devices, or any other medium which can be used to store the desired information, objects and/or data structures that can be accessed by the multiprocessor system 100.

In some embodiments, the shared memory 106 may store programming instructions, data structures, program modules and other data, which, when executed by one or more of the processors 102, implement some or all of the processes described herein. The shared memory 106 may also be organized into cache lines of a fixed size. For example, each cache line may be 64 bytes of data. In general, when a processor 102 cannot find a required object in its local cache memory 104, the processor 102 may retrieve a line-size block of data from the shared memory 106, and may place it in its own cache memory 104.

The multiprocessor system 100 may include (e.g., within the shared memory 106) an operating system 112 configured to, among other things, provide expandable synchronization primitives that allow multiple concurrently-executing threads to access the objects and/or data structures in the shared memory 106. In general, the operating system 112 may include a component-based framework that supports components (including properties and events), objects, inheritance, polymorphism, reflection, and provides an object-oriented component-based application programming interface (API), such as that of the Win32™ programming model and the .NET™ Framework commercially available from Microsoft® Corporation of Redmond, Wash. The operating system 112 may be Windows-based, Unix-based, Linux-based, or any other suitable operating system type.

Any number of the plurality of processors 102 may be concurrently executing one or more threads to carry out certain instructions on the multiprocessor system 100. In some instances, a given thread will carry out an instruction to access an object or data structure in the shared memory 106, which could be done for various purposes. For example, the thread may need to read the object (e.g., copy or print the object), modify the object (e.g., add an item to an existing list of items and/or increment a counter), or take some other action to manipulate the object in some way.

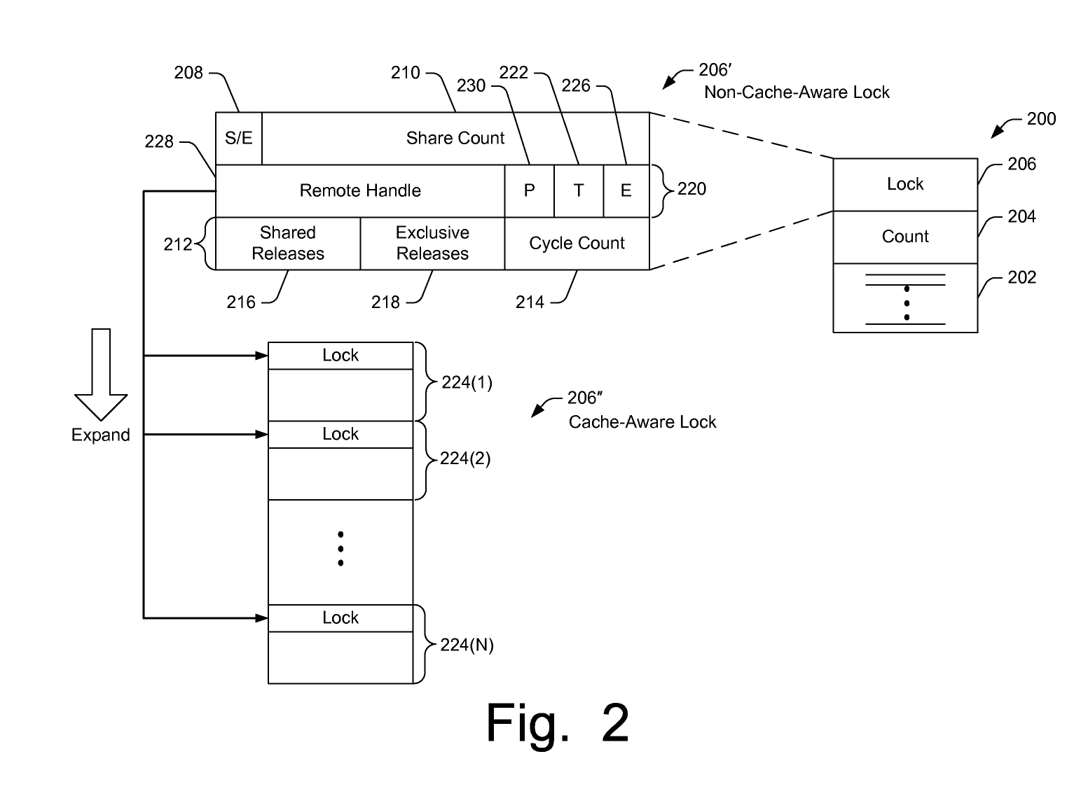

FIG. 2 is a diagram illustrating example data structures that may represent an expandable synchronization primitive for implementation with the multiprocessor system 100. A data structure of an object 200 is shown in FIG. 2. In some embodiments, the object 200 may comprise a data file of a particular file format (e.g., an Excel® spreadsheet, a Word® document, etc.). In the illustrative example, the object 200 may be a file that contains a list of items 202 (e.g., a list of products) that may be representative of the main content of the object 200. The data structure of the object 200 may further include a count field 204 that keeps track of the number of items in the list 202. The data structure of the object 200 may further include, or may otherwise be associated with, an expandable synchronization primitive 206. FIG. 2 represents the synchronization primitive 206 as a lock. Hereinafter, the term “lock” may be used interchangeably with the term “synchronization primitive,” and reference may be made to both in the drawings by using the reference numeral 206. Although a lock 206 is shown in FIG. 2 as an example synchronization primitive, any other suitable type of synchronization primitive may be utilized in lieu of the lock 206, such as, without limitation, a rundown reference, a spinlock, a mutex, and so on. Moreover, the object 200 is merely an example object that may be utilized with the techniques and systems herein, and other object types of varying data structures may be utilized without changing the basic characteristics of the system.

Referring again to FIG. 2, a data structure of the lock 206 is shown in further detail by the reference numeral 206′. The data structure 206′ of the lock 206 represents an unexpanded or collapsed form of the lock 206. The unexpanded/collapsed form of the lock 206 may be referred to herein as a “non-cache-aware” lock 206 to distinguish the unexpanded/collapsed form of the lock 206 from the expanded form of the lock 206, which will be described in more detail below.

As shown in FIG. 2, the data structure 206′ of the non-cache-aware lock 206 may include multiple data fields, such as a data field 208 that indicates whether the lock 206 has been acquired in a shared manner or an exclusive manner. For example, the lock 206 may comprise a read/write lock 206 that is configured to be acquired in either an exclusive manner or a shared manner. To illustrate the exclusive case, a given thread, referred to as an “update” thread, may carry out an instruction to modify data, such as by incrementing the count 204 of the object's data structure. This may be done when an item is added to the list 202. In order to increment the count 204 in this manner, the thread may carry out an “exclusive” acquire of the lock 206 by, for example, setting a bit in the data field 208 to notify other threads that they must wait until the lock 206 is released before the lock 206 can be acquired in either an exclusive or shared manner. After the thread acquires the lock 206 in an exclusive manner, it may read the count 204, add “1” (if incrementing the count, for example), write the new value back, and release the lock 206.

To illustrate the shared case, imagine that there are multiple “reading” threads that each carry out an instruction to copy or print the list of items 202. These reading threads, unlike the update thread in the previous example, do not need to add/delete anything from the list 202 or otherwise increment/decrement the count 204. Thus, multiple reading threads may simultaneously hold the lock 206 in a shared manner. In this example, a given reading thread may carry out a shared acquire of the lock 206 to copy or print the list of items 202. While the reading thread is holding the lock 206 in a shared manner, there may be multiple other threads simultaneously holding the lock 206 in a shared manner to perform similar tasks. Meanwhile, threads that are trying to obtain an exclusive acquire of the lock 206 would be prevented from doing so while the lock 206 is held “shared” by the reading thread(s) so that race conditions are avoided. In this manner, the data structure 206′ of the lock 206 may further include a data field 210 that maintains a reference count of the number of threads that are holding the lock 206 in a shared manner at any given time. This “share count” in the data field 210 may be incremented by each thread that acquires the lock 206 in a shared manner, and may be decremented by each thread that performs a shared release of the lock 206. These operations to increment/decrement the share count in the data field 210 of the lock's data structure 206′ are performed as interlocked operations (i.e., atomic instructions that require a cache line of shared memory to be “owned” by the processor 102 that is executing the thread performing the interlocked operation). For example, a reading thread, upon executing a shared acquire of the lock 206, may read the share count in the data field 210, increment the variable, and write the new value back in order to atomically update the share count in the lock's data structure 206′.

In a scenario where a relatively small number of processors 102 are concurrently performing interlocked operations on the lock 206, the non-cache-aware form of the lock 206 may be suitable for synchronizing the threads' access to the object 200 without a significant impact on throughput of the multiprocessor system 100. However, considering a scenario where there are a large number (e.g., hundreds) of the processors 102 simultaneously performing interlocked operations (e.g., simultaneously acquiring the lock 206 in a shared manner), cache-line contention may rise to a level that significantly impacts system throughput. It is to be appreciated that shared acquires are one example of an interlocked operation that can be performed on the lock 206. Accordingly, other types of interlocked operations (e.g., InterlockedCompareExchange—a function that performs an atomic compare-and-exchange operation on a specified value(s)) are also likely to occur. Thus, given the number of possible interlocked operations that may be performed on the lock 206 at any given time, cache-line contention is a noteworthy concern with the non-cache-aware lock 206.

Accordingly, the data structure 206′ of the lock 206 may include additional data fields, as illustrated in FIG. 2, that provide functionality including: (i) the ability to maintain contention statistics in a compact and efficient way that may be monitored for triggering the expansion of the non-cache-aware lock 206, and (ii) expansion logic to efficiently expand the non-cache-aware lock 206 to a cache-aware form so that cache-line contention can be mitigated when there is demand for it.

Accordingly, the data structure 206′ of the lock 206 may include contention statistics 212, which may track (for a limited period of time) any conceivable metrics or parameters that are useful in determining—directly or by inference—an amount/level of cache-line contention or a similar cost of the operations (e.g., the interlocked operations) being performed on the lock 206. Although the contention statistics 212 are shown as being maintained within the data structure 206′ of the lock 206, it is appreciated that the contention statistics 212 may, in some embodiments, be maintained elsewhere in memory (e.g., elsewhere in the shared memory 106). In such a scenario, the data structure 206′ of the lock 206 may include a pointer to the location in memory where the contention statistics 212 are maintained, or the contention statistics 212 may be keyed to the lock's address in some other suitable manner. Separate maintenance of the contention statistics 212 may reduce the size requirement of the lock's data structure 206′, but may be relatively inefficient for accessing the contention statistics 212. In either case, low memory cost may be achieved by making the contention statistics 212 as compact (i.e., small data size) as possible in order to minimize the memory footprint of non-cache-aware synchronization primitives, such as the lock 206.

FIG. 2 shows the contention statistics 212 as including a data field 214 of the lock's data structure 206′ for maintaining measurements of a parameter. The measurements may be taken during performance of interlocked operations on the lock 206 over a period of time. In the example of FIG. 2, the parameter being measured is specified as the cycle count (or clock-time count) associated with the interlocked operations. For example, clock cycles may be measured during a shared release (or a shared acquire) of the lock 206 and maintained in the data field 214 as part of a process of collecting the contention statistics 212. In this scenario, the cycle count parameter may be utilized to determine a level of cache-line contention resulting from operations on the non-cache-aware synchronization primitive 206 by a comparison of the measured clock cycles to some baseline value of the parameter that represents a value when the operations are performed without cache-line contention. For example, a per-operation cycle count may be compared to some baseline or “normal” per-operation cycle count for a given operation. As noted above, since shared acquires (and shared releases) of the non-cache-aware lock 206 typically involve one or more interlocked (atomic) operations, cache-line contention is expected to significantly increase as these types of operations are performed, thereby increasing the number of cycles necessary for the operations. By measuring the cycle count and calculating a statistical value (e.g., average or mean, median, mode, minimum, maximum, etc.) of the cycle count based on the measurements that are taken over time, and comparing the statistical value to a baseline value for the uncontended cycle count for that operation, a level of cache-line contention may be determined (or deduced) to decide whether there is a suitable demand for expanding the non-cache-aware lock 206. For example, expansion may be triggered if an average/per-operation cycle count exceeds the baseline value, or if the average/per-operation cycle count exceeds the baseline value by a threshold percentage (e.g., by more than 25%), and so on.

The baseline value of the parameter (e.g., cycle count) may be statically hard-coded within the multiprocessor system 100 (e.g., hard-coded in the shared memory 106), it may be measured at boot time of the multiprocessor system 100 by performing the particular operation (e.g., repeatedly performing an interlocked operation) on the lock 206 when there is no cache-line contention, or it may be configured by an administrator of the multiprocessor system 100. The measured baseline value may then be stored in memory (e.g., the shared memory 106).

In some embodiments, the parameter measured in the data field 214 may comprise a number of InterlockedCompareExchange “retries” during performance of an acquire or release of the non-cache-aware lock 206. Such retries may indicate that another processor 102 has modified the lock state at the same time, thus signaling cache-line contention. For example, if the count of InterlockedCompareExchange retries per “N” acquires/releases reaches a predetermined a threshold value for the retry parameter, the non-cache-aware lock 206 may be expanded. This threshold value, like the baseline value for the cycle count parameter, may be statically hard-coded in the multiprocessor system 100, it may be computed at boot time of the multiprocessor system 100 by measuring a point at which retries become a performance bottleneck, or it may be configured by an administrator of the multiprocessor system 100. The measured point may then be stored as the retry threshold value.

In some embodiments, the parameter measured in the data field 214 may comprise a frequency of acquire or release operations for the non-cache-aware lock 206. This frequency parameter may be measured by counting acquire/release operations over a unit of time. The acquire/release frequency parameter may then be compared to a threshold value to decide if the operations are being performed at a frequency that exceeds the threshold, which may mean that the operations are likely to be impacted by cache-line contention. The threshold frequency may be statically hard-coded in the multiprocessor system 100, the threshold frequency may be computed at boot time of the multiprocessor system 100 by forcing cache-line contention on a cache-line, and then measuring the frequency at which operations cause a performance problem, or the threshold may be configured by an administrator of the multiprocessor system 100. This measured frequency may then be stored as the threshold frequency.

Other suitable parameters that are indicative of a level of cache-line contention may be measured besides those specifically described herein. With any suitable parameter, by collecting measured values of the parameter in the data field 214 and comparing an associated value of those measurements with a baseline or threshold value, a mechanism for triggering expansion of the non-cache-aware lock 206 may be provided.

In order to reduce the memory footprint occupied by the collected statistics 212, a scaling factor may be applied to the measured parameter in the data field 214 to reduce the memory that is allocated for storing the data in the field 214. Computation of the scaling factor may be based on the cost of an uncontended interlocked operation such that the parameter measurements in the data field 214 may be represented in units of the scaled, uncontended cost

$$( e . g . , \frac{Uncontended cost}{4} ) .$$

This may allow as few as 16 bits to sufficiently represent the measured parameter (e.g., the total cycle count) over hundreds of measurements. By scaling down the data in the data field 214, the collected statistics 212 may be compactly and cheaply stored in order to reduce the memory footprint of the non-cache-aware lock 206.

The operations that the collected statistics 212 are based on may comprise acquire operations or release operations of a non-cache-aware synchronization primitive 206. Thus, the contention statistics 212 may be measured or collected during an acquire operation, a release operation, or both. Measuring/collecting the contention statistics 212 in the release code path may occur during an interlocked operation that doesn't actually release the lock 206 so that computation may be reduced while the synchronization primitive 206 is held (i.e., computations based on the collected statistics 212 may be performed when the lock is not being held). In this scenario, the contention statistics 212 may still be updated before the lock is actually released. By contrast, measuring/collecting the contention statistics 212 in the acquire code path may involve waiting for the lock 206 to be released. However, the measuring/collecting of the contention statistics 212 in the acquire code path may not carry the risk of the lock 206 potentially being asynchronously destroyed; a risk that is present during a release operation. Regardless of where the measuring/collecting takes place, the parameter may be measured and updated within the data field 214 in the contention statistics 212.

In some embodiments, the instruction of updating the contention statistics 212 may not be an atomic instruction. In this scenario, the contention statistics 212 may be lossy. However, updating the contention statistics 212 without using interlocked operations minimizes the cost associated with acquires or releases of the synchronization primitive 206. Moreover, the contention statistics 212 may still be consistent because they may be computed as local variables and updated using a single store instruction.

In some embodiments, the contention statistics 212 may further include a data field 216 for maintaining a count of the number of shared releases (or shared acquires) of the lock 206, and a data field 218 for maintaining a count of the number of exclusive releases (or exclusive acquires) of the lock 206. The counts in the data fields 216 and 218 may be maintained over a period of time within which the parameter is measured in the data field 214. The period of time over which the contention statistics 212 are collected and maintained may occur over the course of multiple operations performed on the lock 206. By maintaining the counts in the data fields 216 and 218, a ratio of exclusive acquires/releases to shared acquires/releases may be evaluated. This may be useful for determining a cost of expanding the lock 206 to a cache-aware form, given that it is expensive (from a throughput standpoint) to perform a relatively high number of exclusive acquires/releases for “cache-aware” (i.e., expanded) synchronization primitives. This expense is due to the fact that an exclusive acquire of a cache-aware synchronization primitive requires that all of the replicated synchronization primitives in the cache-aware synchronization primitive be acquired by the thread. Thus, by monitoring the number of exclusive acquires/releases relative to shared acquires/releases (e.g., a ratio of the number of exclusive acquires or releases to the number of shared acquires or releases), expansion can be avoided if a significant percentage of the acquires of the lock 206 are exclusive acquires.

In some embodiments, the size of the data representing the contention statistics 212 may be no greater than about 32 bits. In this scenario, the size of the shared release count data field 216 may be no greater than about 12 bits, the size of the exclusive release count data field 218 may be no greater than about 4 bits, and the size of the cycle count data field 214 may be no greater than about 16 bits. As the contention statistics 212 are updated, the entire 32 bit value of the contention statistics 212 may be updated using a single store instruction. This compact size of the contention statistics 212 allows for cheap maintenance of non-cache-aware synchronization primitives.

In some embodiments, as the contention statistics 212 are collected, the multiprocessor system 100 may further monitor whether context switches occur during a parameter measurement. A context switch is a process of storing and restoring the state (context) of a thread so that execution can be resumed from the same point at a later time. Because context switches may skew the measured parameter values in the field 214 by a thread being context switched out after attempting an acquire operation, maintaining a count of context switches that occur per thread allows for the measurements impacted by context switches to be ignored. In other words, parameter measurements taken during context switches can be discarded or thrown out of the data set of the collected statistics 212 so that the cost of the operations on the synchronization primitive 206 is not skewed by context switching.

As the contention statistics 212 are collected, the parameter (e.g., cycle count) may be measured and maintained in the data field 214 over the course of several operations that are performed on the synchronization primitive 206. In some embodiments, the measurements maintained in the data field 214 may be sampled measurements in order to reduce per-operation processor cost. For example, every 16^{th} operation may be sampled for measurement until a sufficient number of samples are taken to calculate a statistical value (e.g., an average) of the measured parameter on a per-operation basis. An average value calculated from multiple measurements taken over time may reduce the risk of temporary spikes or anomalies that are manifested in contention statistics 212.

When it is determined, based on the contention statistics 212, that cache-line contention is at a high enough level to warrant expansion of the non-cache-aware synchronization primitive 206, expansion logic may be used to efficiently expand the non-cache-aware synchronization primitive 206 to a cache-aware (expanded) form. Specifically, when it is time to expand the non-cache-aware synchronization primitive 206, there may be multiple threads that are in the process of acquiring, and/or currently holding, the non-cache-aware synchronization primitive 206. The expansion logic utilized for expanding the non-cache-aware synchronization primitive 206 may therefore safeguard such threads from crashing, and/or honor the fact that they are acquiring or holding the synchronization primitive 206 that is in the process of expanding. In order to accomplish this task, the data structure 206′ of the non-cache-aware lock 206 may further include one or more expansion logic data fields 220 that allow for the efficient and safe expansion of the synchronization primitive 206 to its cache-aware form.

The expansion logic data fields 220 may include a data field 222 containing a transition bit, T, which is to be set by a thread that is instructed, by the operating system 112, to expand the synchronization primitive 206. In order to set the T-bit, the thread may perform an interlocked operation on the lock 206, and, if successful, the thread that set the T-bit is then responsible for attempting expansion of the synchronization primitive 206. FIG. 2 illustrates this expansion as a memory allocation technique where a plurality of cache lines 224(1), 224(2), . . . , 224(N) (collectively 224) may be individually allocated to respective processors 102 of the multiprocessor system 100 so that threads may perform operations on their own (i.e., their processor's own) cache line. In some embodiments, the memory allocation technique may include allocating less than a full cache-line (which is typically on the order of 64 bytes) to individual ones of the processors 102 so that data for multiple synchronization primitives 206 may be maintained in individual ones of the cache lines 224. In either case, the cache lines 224 are allocated on per-processor/node states to avoid cache-line contention. This type of expanded data structure is shown by reference numeral 206″ in FIG. 2, and the expanded data structure 206″ may represent a “cache-aware” form of the synchronization primitive 206. The lock 206 may point to the array of cache lines 224(1)-(N) where each cache line 224 is allocated for an individual processor 102 and represents a replica of the non-cache aware synchronization primitive 206 that is to be acquired for a given object 200. The cache-aware form of the synchronization primitive 206 may increase throughput of the multiprocessor system 100 by mitigating, or altogether eliminating cache-line contention for shared acquires of the synchronization primitive 206 because a particular thread performing a shared acquire merely identifies the cache line 224 that corresponds to its processor 102 in order to acquire the replica of the synchronization primitive 206 on that particular cache line 224. By contrast, an update thread that is attempting to perform an exclusive acquire of the synchronization primitive 206 is required to acquire all of the cache lines 224(1)-(N), which can negatively impact throughput of the multiprocessor system 100. The assumption here is that exclusive acquires are rare as compared to shared acquires in many multiprocessor systems 100, so the throughput benefits afforded by the cache-aware synchronization primitive's data structure 206″ outweigh any downsides by providing the expanded data structure 206″.

Referring again to the expansion logic data fields 220, once the thread that is responsible for attempting expansion of the lock 206 successfully expands the non-cache-aware lock 206 to the cache-aware lock 206, the thread may update the lock's state with a T-bit clear in the data field 222, and may set an expansion bit, E, in data field 226 of the lock's data structure 206′ to indicate that the lock 206 has been expanded to its cache-aware form as the expanded data structure 206″. During an attempted expansion, if one thread is not successful in expanding the non-cache-aware lock 206 for any reason, the T-bit may be cleared using a single store instruction such that another thread can attempt expansion.

Regardless of whether the lock 206 was successfully expanded or not, any thread that performs a shared acquire of the lock 206 checks the E-bit to see if the lock 206 is expanded to its cache-aware form. If the E-bit is set upon this check, the thread may then identify the particular cache line 224 corresponding to its processor 102 so that the thread may take ownership of that cache line 224 and perform one or more interlocked operations on the particular cache line 224. The cache line 224 owned by the calling thread represents the acquired lock, which may then be encoded into a remote handle 228 and returned to the calling thread. The remote handle 228 may be opaque in the sense that the calling thread doesn't know what the remote handle 228 represents. The calling thread may pass the remote handle 228 to the release function, and the release path may use the remote handle 228 to determine which lock in the expanded data structure 206″ to release.

In some embodiments, one or more threads may hold the non-cache-aware lock 206 in a shared manner while another thread expands the lock 206 (e.g., by setting the T-bit, allocating memory, clearing the T-bit, and setting the E-bit). This allows expansion to occur without waiting for threads to release the non-cache-aware lock 206 (i.e., efficient expansion), while honoring the fact that certain threads are holding the non-cache-aware lock 206.

In some embodiments, the expansion logic data fields 220 may omit the data field 222 for the T-bit and rely on the E-bit within the data field 226 of the lock's data structure 206′ for the expansion logic. In this scenario, threads that are attempting expansion of the non-cache-aware lock 206 may abort the expansion attempt if the thread sees the E-bit set during a write-back attempt. The inclusion of the T-bit in the data field 222 may optimize performance, however, by preventing threads from attempting expansion of the non-cache-aware lock 206 concurrently.

In some embodiments, a single state may be used to encode information regarding the current state of expansion of the lock 206. For example, “0” may indicate an unexpanded state, “1” may indicate a transitioning state, “2” may indicate a do-not-expand state, and “3” may indicate an expanded state for a given lock 206. This embodiment allows for tracking states without using separate bits. Thus, a transitioning state of a non-cache-aware lock 206 may be represented by setting the T-bit, for example, but tracking a transitioning state is not limited to such implementation. Likewise, an expansion state may be represented by setting the E-bit, for example, but tracking an expansion state is not limited to such implementation.

In some embodiments, the data structure 206′ of the non-cache-aware lock 206 may further include a data field 230 that includes a paged bit, P, to indicate whether the lock 206 is a “paged” lock or a “non-paged” lock. The P-bit indication may be useful for implementing appropriate contraction logic for contracting the cache-aware synchronization primitive, as described in more detail below. The P-bit may also be used to determine a type of pool (i.e., paged or non-paged) to allocate for the cache-aware lock 206. In some embodiments, locks 206 that are acquired in non-paged code paths may be paged.

As noted above, the large memory footprint of cache-aware synchronization primitives is a downside of their implementation. Therefore, the cache-aware synchronization primitive 206 may be collapsible to revert the cache-aware synchronization primitive 206 to its non-cache-aware (i.e., collapsed or unexpanded) form. The operating system 112 may provide contraction logic for contracting the expanded data structure 206″ when it is determined or inferred that cache-line contention has subsided or decreased to a level where the cache-aware synchronization primitive 206 is no longer needed. Thus, expansion and contraction of the synchronization primitive may occur “on-demand” as cache-line contention increases and decreases in severity.

In some embodiments, contraction of the cache-aware synchronization primitive 206 may occur after a period of time has lapsed since the expanding. For example, the cache-aware synchronization primitive 206 may collapse/contract after a period of about a second. The period of time from expansion to contraction may, in some cases, be device-dependent in the sense that the time period varies by the type of multiprocessor system 100 and/or the number of processors 102 on the multiprocessor system 100. By contracting after the lapse of a period of time, it may be inferred that cache-line contention has subsided after this time period. However, if cache-line contention has not subsided after the prescribed period of time, the multiprocessor system 100 may simply rely on the efficient expansion logic to once again expand the non-cache-aware synchronization primitive 206 in response to detection of significant cache-line contention. Periodically contracting cache-aware synchronization primitives in this manner allows for implementing cache-aware synchronization primitives that do not maintain any contention statistics. Maintaining contention statistics for cache-aware synchronization primitives may be counter-productive from a throughput standpoint because such maintenance may cause an increase in cache-line contention, which is what the cache-aware synchronization primitive 206 aims to avoid. However, in some embodiments, post-expansion statistics may be maintained in a “contention-free manner” (i.e., without causing a significant increase in cache-line contention).

Accordingly, contracting the cache-aware synchronization primitive 206 may be further conditioned upon additional criteria besides time. One example criterion for deciding when to contract the cache-aware synchronization primitive 206 may be that the number of exclusive acquires (or exclusive releases) is above a threshold number of exclusive acquires/releases. A high number of exclusive acquires of the cache-aware synchronization primitive 206 is costly from a throughput standpoint, so it may be beneficial to contract those cache-aware synchronization primitives that experience a high number of exclusive acquires.

Another example criterion for contracting may be that the rate of shared acquires (or shared releases) of the cache-aware synchronization primitive 226 is lower than the rate of shared acquires/releases before the cache-aware synchronization primitive 206 was expanded. A rate of shared acquires/releases may be indicative of the level of “activity” with respect to that synchronization primitive, such that, if it is determined that activity has dropped post-expansion, it is probably safe to contract the cache-aware synchronization primitive 206. Another example criterion for contracting may be that a ratio of the number of shared acquires (or shared releases) to the number of exclusive acquires (or exclusive releases) is below a threshold ratio, which indicates that the cache-aware synchronization primitive 206 may be experiencing little activity. In some embodiments, calculation of these metrics may be performed at the time of an exclusive acquire performed by an update thread.

Maintenance of post-expansion statistics to determine the aforementioned contraction criteria may be done in a contention-free manner by maintaining statistics per cache line 224 of the expanded data structure 206″ for the cache-aware synchronization primitive 206. For example, a count of the number of shared acquires/releases of the cache-aware synchronization primitive 206 may be kept per cache line 224 with respect to the processors 102 that are behind the performance of those operations. Meanwhile, exclusive acquire counts may be maintained globally with respect to the expanded data structure 206″.

Contracting a cache-aware synchronization primitive 206 may be further conditioned upon additional criteria that help ensure that contraction is being performed as infrequently as possible. It is recognized that contracting a cache-aware synchronization primitive 206 may cause more of an interruption to the multiprocessor system 100 than any interruption experienced as a result of the expansion process for a synchronization primitive. Thus, it may be wise to contract sparingly. Accordingly, the contraction of any given cache-aware synchronization primitive 206 may be conditioned on a criterion that a number of cache-aware synchronization primitives on the multiprocessor system 100 exceeds a threshold number of cache-aware synchronization primitives at the time that contraction of one or more of the cache-aware synchronization primitives is contemplated. In order to determine the number of cache-aware synchronization primitives on the multiprocessor system 100 at any given time, and in order to determine which cache-aware synchronization primitives are eligible for contraction, the cache-aware synchronization primitives may be registered with a central authority (or shared registry) once they are expanded. Such registration may include allocating an explicit registration entry that includes a pointer to the registered cache-aware synchronization primitive 206 for each cache-aware synchronization primitive 206, and maintaining a list of registration entries. In some embodiments, a registration list for paged/pageable synchronization primitives may be maintained separately from another registration list for non-paged/non-pageable synchronization primitives. Once the registered synchronization primitives are contracted, they may be removed from the registration list.

Other conditions for contraction of a cache-aware synchronization primitive 206 may be applied to ensure that contraction is being done in a “safe” manner. That is, it may be unsafe to contract a cache-aware synchronization primitive 206 while one or more threads are holding the cache-aware synchronization primitive 206, and/or if there are any “in-flight” threads that are trying to perform a shared acquire of the cache-aware synchronization primitive 206 when contraction begins. Thus, in one example, the operating system 112 may wait to contract until there are no threads holding the cache-aware synchronization primitive 206. This may involve waiting for an exclusive release, or waiting for a count of shared owner threads to reach zero before contracting. In some embodiments, the operating system 112 may wait to contract until there are no cache-aware synchronization primitives on the multiprocessor system 100 being held by any thread. This scenario may lead to less frequent contraction, but may also result in unneeded maintenance of cache-aware synchronization primitives (e.g., when a single lock 206 is being held by a thread)

In some embodiments, the operating system 112 may determine whether there are any threads that are about to acquire an allocated cache line 224 of the cache-aware synchronization primitive 206 (i.e., whether there are any “in-flight” threads). The determination of in-flight threads may be based on checking a list of in-progress lock acquires for individual ones of the threads. For example, if a given thread is performing a shared acquire of the cache-aware synchronization primitive 206, it may first check the E-bit in the data field 226 to determine that the synchronization primitive 206 is in its expanded form, and then register its in-progress acquire operation in a list of in-progress lock acquires for that thread. Upon this registration, the thread has not yet accessed the cache-line 224 corresponding to its processor 102.

In some embodiments, an in-stack data structure containing a synchronization primitive pointer and a balanced tree entry can be added to the list of in-progress lock acquires for a given thread. At context switch time, this list can be walked and the entries inserted into a per-processor tree that is keyed by the lock's address on the context switching processor 102. In this manner, there may be a periodic task that runs to see if there are any cache-aware synchronization primitives on the multiprocessor system 100 that are eligible for contraction, and for each candidate identified, the task may check the per-processor tree to see if there are any in-flight threads on that candidate synchronization primitive. If there are one or more in-flight threads according to the per-processor tree, the candidate synchronization primitive may not be contracted.

In some embodiments, determining whether there are in-flight threads for a candidate synchronization primitive may be based on checking whether a thread-local bit is set for individual ones of the threads. A thread-local bit can be set before accessing the cache lines 224 of the cache-aware synchronization primitive 206, and subsequently cleared when accessing a respective cache line 224 is successfully completed. During a context switch, the value of this bit may be added to a counter on the processor 102 performing the context switch.

In either case (i.e., a per-processor tree that is keyed by the lock's address or a thread-local bit), in-flight threads may be tracked before a cache-aware synchronization primitive 206 is contracted, and if any in-flight threads are detected, the operating system 112 may refrain from contracting the cache-aware synchronization primitive 206. The assumption is that it is a rare case to be context switched out in the time between a thread checking the E-bit and the thread acquiring the per-processor cache line 224 of the cache-aware synchronization primitive 206. Based on this assumption, the list of in-flight threads at any given time is likely to be small and cheap to maintain. Furthermore, it is expected that the condition of detecting zero in-flight threads is likely to occur relatively frequently.

In some embodiments, an operating system interrupt on the plurality of processors 102 may be performed while checking whether there are any in-flight threads and/or any threads holding a cache-aware synchronization primitive 206 that is a candidate for contraction. This interrupt may include sending an interrupt to each processor 102 to see what the respective processors are doing. In the example where a per-processor tree of in-flight threads is maintained, the operating system interrupt may be executed by running code on all processors 102 during the check of the per-processor tree. In one scenario, an in-flight thread may have context switched out. In this scenario, the thread's in-stack registration may be added to the global tree keyed by the lock address so that the in-flight thread that context switched out can be found. Since the operating system 112 owns the context switch code, if there is such an in-flight thread that was context switched out, the operating system code may determine that the thread was context switched out during a shared acquire so that the thread can be remembered in this manner. In another scenario, there may be an in-flight thread that has not context switched out yet (which means that the in-flight thread is running on a processor 102 when the operating system interrupt occurs). In this scenario, the in-flight thread would have registered its in-stack entry, but the entry may not have been transferred to the global tree yet. Thus, the in-flight thread that was running on the processor 102 may be checked when the operating system interrupt occurs for each processor 102, and the list of registered entries in the global tree may be walked to see whether the candidate lock 206 for contraction is in that list. The thread-local bit approach may handle the aforementioned scenarios similarly to the per-processor tree approach.

The contraction logic that is utilized for contracting the cache-aware synchronization primitive 206 may be based on whether the synchronization primitive 206 is paged or non-paged. As noted above, the non-cache-aware synchronization primitive 206 may include a data field 230 to indicate whether the synchronization primitive 206 is paged or non-paged. Since the operating system 112 cannot touch paged memory (invalid memory) with code that runs on each processor 102 simultaneously, paged cache-aware synchronization primitives may be pinned to a location in the shared memory 106 to effectively convert the paged synchronization primitive to a non-paged synchronization primitive.

For non-paged synchronization primitives, each non-paged synchronization primitive that is in an expanded form (i.e., cache-aware form) may be registered on a non-paged registration list. The contraction logic for such non-paged synchronization primitives may operate by corralling all processors 102 at dispatch level so that they are spinning at dispatch level, and walking the non-paged registration list to find a candidate synchronization primitive for contraction. A check may be performed to see if the candidate synchronization primitive can be contracted safely. As noted above, if a per-processor tree keyed by the synchronization primitive's address is utilized to detect in-flight threads, the per-processor tree data structure may be searched for the candidate synchronization primitive's address, and if it is found, the candidate synchronization primitive may not be contracted. Additionally, any in-flight thread that was running on a particular processor 102 may be checked during an operating system interrupt, and the list of registered entries in the global tree may be walked to see whether the candidate synchronization primitive is in that list, and, if so, it may not be contracted Alternatively, if a thread-local bit is used to track in-flight threads, a check may be performed to determine if any processor 102 has a non-zero counter value indicating that there are one or more in-flight threads, and the synchronization primitive may not be contracted if the non-zero condition is met.

If, on the other hand, no in-flight threads are detected, the candidate synchronization primitive may be contracted by updating the synchronization primitive state to an unexpanded/collapsed state. This may include aggregating shared acquires of the candidate synchronization primitive, clearing the E-bit in the data field 226, and resetting the contention statistics 212. The per-processor cache line 224 memory allocation may be “snapped” for the candidate synchronization primitive, and its registration entry removed from the non-paged registration list before the corralled processors 102 are released. After the processors 102 are released, the operating system 112 may free the registration entry and the per-processor cache line 224 memory allocation.

For paged synchronization primitives, each paged synchronization primitive in expanded form (i.e., cache-aware form) may be registered on a paged registration list. Accordingly, contraction logic for contracting paged synchronization primitives may operate by acquiring a lock for the paged registration list, walking the paged registration list to find a candidate synchronization primitive for contraction, and calling a memory manager to pin the candidate synchronization primitive in the shared memory 106 such that subsequent accesses (which will be performed at dispatch level where page faults cannot be taken) won't take page faults. The remainder of the contraction logic may follow that of the non-paged locks, described above. If contraction is successful by freeing the per-processor cache-line 224 memory allocation, the registration entry for the contracted synchronization primitive may be removed from the paged registration list.

As noted above, the lock 206 illustrated in FIG. 2 is but one example of a synchronization primitive that may be utilized with the techniques and systems described herein. For example, a rundown reference may be expandable to a cache-aware rundown reference in a similar manner to that described above for the example lock 206. A rundown reference, like a lock, may be acquired in a shared manner or an exclusive manner, and therefore, may be represented by a data structure that is similar to the data structure 206′ of the non-cache-aware lock 206 shown in FIG. 2 so that contention statistics 212 may be collected for the rundown reference to determine when to expand, and expansion logic may expand the rundown reference in an efficient manner. The rundown reference may then be contracted when cache-line contention has subsided.

### Example Processes

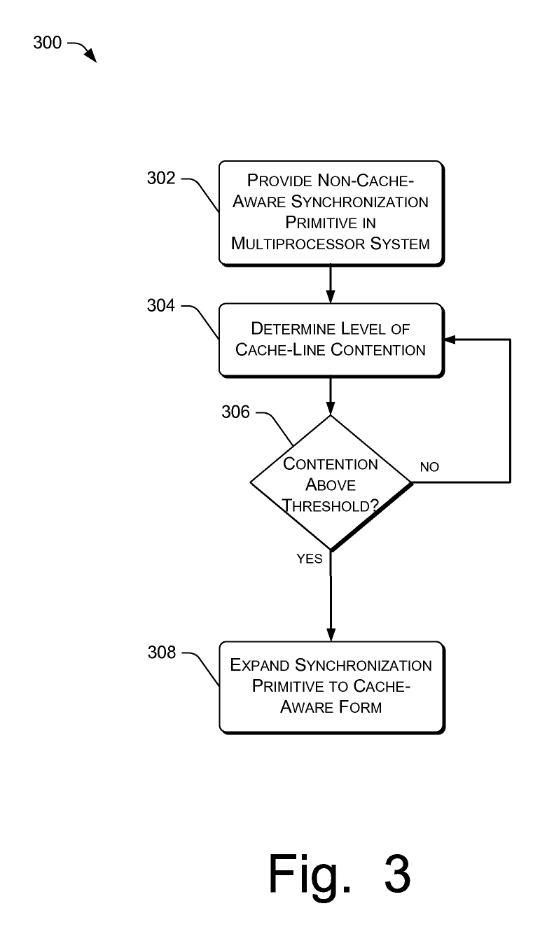

FIGS. 3-6 illustrate processes as a collection of blocks in a logical flow graph, which represents a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

FIG. 3 is a flow diagram of an illustrative process 300 for expanding a non-cache-aware synchronization primitive on-demand. For discussion purposes, the process 300 is described with reference to the multiprocessor computer system 100 of FIG. 1, and the data structures 206′ and 206″ shown in FIG. 2.

At 302, a non-cache-aware synchronization primitive 206 (e.g., a lock) may be provided in a multiprocessor computer system 100 having shared memory 106. Multiple threads may perform operations (e.g., interlocked operations) on the non-cache-aware synchronization primitive 206 to access objects or data structures in the shared memory 106. These operations may cause cache-line contention in the multiprocessor system 100.

At 304, the operating system 112 of the multiprocessor system 100 may determine a level of cache-line contention resulting from the operations on the non-cache-aware synchronization primitive 206. In some embodiments, the level of cache-line contention may be determined by measuring a parameter (e.g., cycle count) during performance of the operations over a period of time.

At 306, a determination may be made as to whether the level of cache-line contention determined at 304 exceeds a threshold level. The determination at 306 may involve determining whether a baseline value of a parameter indicative of cache-line contention is exceeded by a measured value of the parameter obtained at 304. In some embodiments, the determination at 306 may involve determining whether the level of cache-line contention is significantly greater than a baseline contention (e.g., above a certain percentage greater than the baseline contention).

If it is determined at 306 that the level of cache-line contention is above a threshold level, the process 300 may proceed to 308 where the non-cache-aware synchronization primitive 206 is expanded to a cache-aware synchronization primitive 206 that allocates individual cache lines 224 of the shared memory 106 to respective processors 102 of the multiprocessor system 100. This on-demand expansion provided by the process 300 expands synchronization primitives when the level of cache-line contention demands that they be expanded to improve throughput of the multiprocessor system 100.

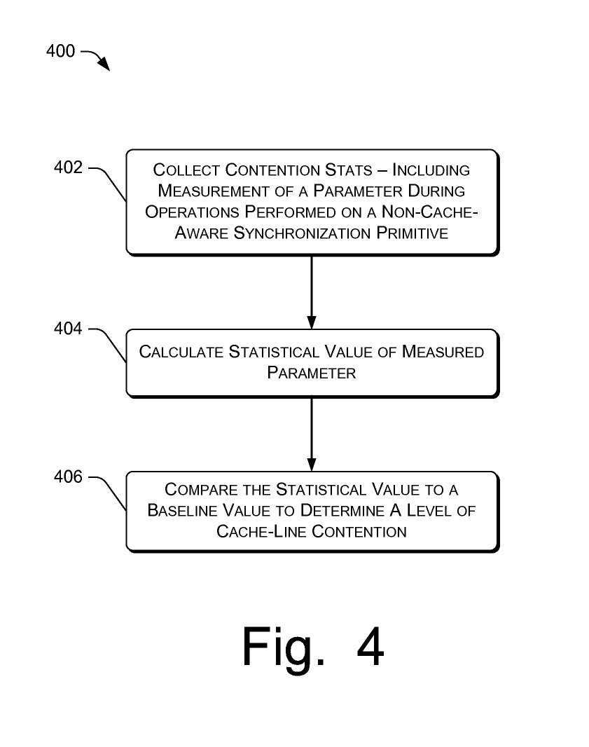

FIG. 4 is a flow diagram of an illustrative process 400 for determining whether cache-line contention is at a level that triggers expansion of a non-cache-aware synchronization primitive 206. The process 400 may be a sub-process of steps 304 and 306 of the process 300 shown in FIG. 3. For discussion purposes, the process 400 is described with reference to the multiprocessor system 100 of FIG. 1, and the data structure 206′ shown in FIG. 2. Specifically the process 400 is described with reference to the contention statistics 212 shown in the data structure 206′ of the non-cache-aware lock 206.

At 402, contention statistics 212 may be collected for a non-cache-aware synchronization primitive 206. The contention statistics 212 collected at 402 may include at least a parameter measurement taken during performance of operations (e.g., interlocked operations) on the non-cache-aware synchronization primitive 206 over a period of time. The period of time over which the parameter measurements are taken may be dictated by a predetermined number of measurements that allow for an accurate assessment of cache-line contention. For example, the collection of contention statistics 212 at step 402 may be based on a constraint that a sufficient number of measurements (e.g., 128 measurements) of the parameter be taken before cache-line contention is assessed. Thus, 128 cycle count measurements during performance of interlocked operations (e.g., shared acquires) on the non-cache-aware synchronization primitive 206 may be taken at 402. In some embodiments, the collection at 402 may include taking parameter measurements at a predetermined sampling frequency (e.g., every 16^{th} shared acquire operation). Sampling the shared acquire operations in this manner (as opposed to measuring every shared acquire or release) reduces per-operation processor 102 cost, and the sampling frequency may be adjusted to provide minimal impact on performance.

Continuing with the cycle count example, if the goal is to take 128 cycle count measurements in order to properly assess a level of cache-line contention, the period of time over which the contention statistics are collected at 402 may correspond to the time required for 2048 shared acquires to be performed on the non-cache-aware synchronization primitive 206. With a sampling frequency of 1 out of every 16^{th} shared acquire, this would result in taking 128 measurements of cycle count

$$( \frac{2048}{16} = 128 ) .$$

The 128 cycle count measurements may be totaled in the data field 214 shown in FIG. 2 to maintain a total cycle count for a predetermined number of operations, and the total cycle count may be stored as a value that is no greater than about 16 bits. The 16 bit value may be achieved by scaling down the total cycle count by a scaling factor to reduce its memory size. In some embodiments, the total cycle count obtained at 402 may be stored as part of the data structure 206′ of the non-cache-aware synchronization primitive 206.

At 404, a statistical value of the parameter measured at 402 may be calculated. Continuing with the cycle count example, after the 128 cycle count measurements have been taken, the total cycle count value in the data field 214 may be divided by the number of measurements (e.g., 128 sampled measurements) to obtain a per-operation cycle count as the average value (i.e., the statistical value) at 404. As noted above, the average value calculated at 404 eliminates temporary spikes in the data that may occur for a subset of the operations monitored. In other embodiments, after a number of measurements are taken, medians of sample subsets may be calculated and averaged to obtain a statistical value as a measure of the parameter.

At 406, the statistical value calculated at 404 may be compared to a baseline value of the parameter, which represents a value of the parameter when the operations are performed without cache-line contention. In the cycle count example, cycle count measurements may be taken at boot time of the multiprocessor system 100 to determine a baseline value for the cost of uncontended interlocked operations on a given cache-line in shared memory 106. Alternatively, the baseline cycle count may be statically hard-coded in the shared memory 106, or it may be configured by an administrator of the multiprocessor system 100. At 406, the per-operation cycle count from step 404 may be compared to this baseline cycle count, and if the per-operation cycle count from step 404 is significantly higher than the uncontended, baseline value (e.g., by more than 25%), this may trigger the expansion of the non-cache-aware synchronization primitive 206. If expansion is not triggered based on the comparison at 406, the contention statistics 212 may be reset for the next measurement period.

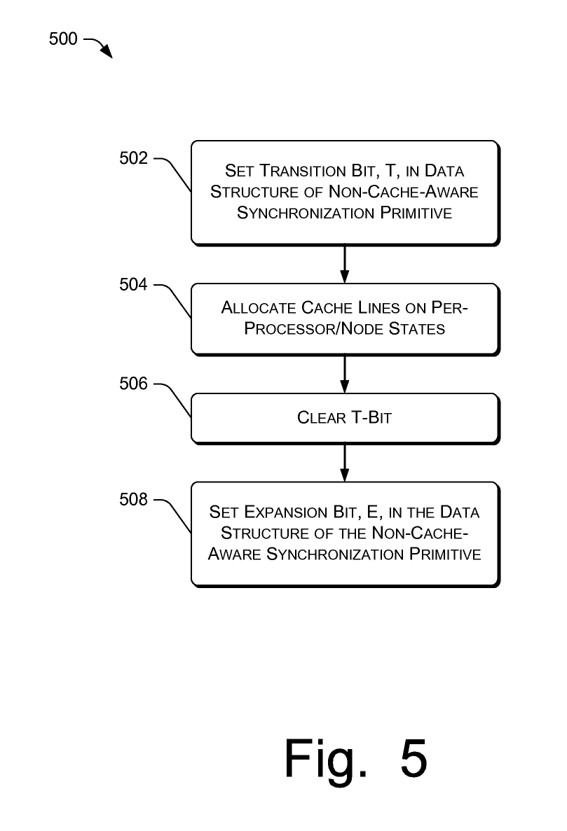

FIG. 5 is a flow diagram of a more detailed illustrative process 500 for expanding a non-cache-aware synchronization primitive 206. The process 500 may be a sub-process of step 308 of the process 300 shown in FIG. 3. For discussion purposes, the process 500 is described with reference to the multiprocessor system 100 of FIG. 1, and the data structure 206′ shown in FIG. 2. Specifically the process 400 is described with reference to the contention statistics 212 shown in the data structures 206′ and 206″ of FIG. 2.

At 502, when it has been determined that a non-cache-aware synchronization primitive 206 is to be expanded, a thread may attempt to expand the non-cache aware synchronization primitive 206 by setting a transition bit, T, maintained within a data structure 206′ of the non-cache-aware synchronization primitive 206. The setting of the T-bit at 502 may, in some instances, occur while at least one thread is holding the non-cache-aware synchronization primitive based on a shared acquire from the at least one thread.

At 504, cache lines 224 are allocated in shared memory 106 of the multiprocessor system 100 on a per-processor/node state. For example, cache lines 224 may be allocated as shown in the data structure 206″ of FIG. 2.

At 506, upon successfully allocating the cache lines 224, the thread that set the T-bit may clear the T-bit. At 508, the thread may set an expansion bit, E, maintained within the data structure 206′ of the non-cache-aware synchronization primitive 206.

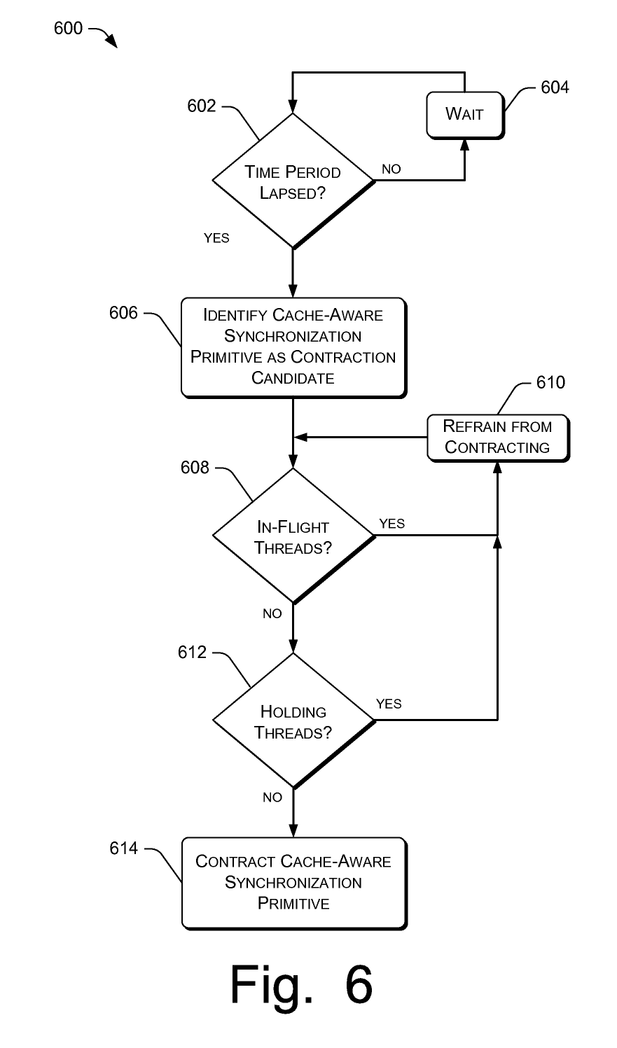

FIG. 6 is a flow diagram of an illustrative process 600 for contracting a cache-aware synchronization primitive 206. For discussion purposes, the process 600 is described with reference to the multiprocessor system 100 of FIG. 1, and the data structure 206″ shown in FIG. 2.

At 602, a determination may be made as to whether a time period has lapsed since a cache-aware synchronization primitive 206 was expanded. If not, the operating system 112 of the multiprocessor system 100 may continue to wait at 604 until the time period has lapsed. Once the time period has lapsed since the expansion of the cache-aware synchronization primitive 206, the cache-aware synchronization primitive may be identified as a candidate for contraction at 606.

At 608, a determination may be made as to whether there are any “in-flight” threads (i.e., threads that are about to acquire an allocated cache line 224 of the cache-aware synchronization primitive's data structure 206″. This determination at 608 may be based on a thread-local bit for individual threads, or based on checking a list of in-progress lock acquires in a per-processor tree. If one or more in-flight threads are detected at 608, the operating system 112 may refrain from contracting the cache-aware synchronization primitive 206 at step 610. If no in-flight threads are detected at 608, the operating system 112 may check to see if there are any threads currently holding the cache-aware synchronization primitive 206 at step 612. If so, the operating system may continue to refrain from contracting the synchronization primitive at 610.

If there are no in-flight threads, and there are no threads holding the cache-aware synchronization primitive 206, the synchronization primitive may be contracted to a non-cache-aware form. The contraction at 614 may include freeing the allocated cache lines 224 in the shared memory 106 of the multiprocessor system 100.

The environment and individual elements described herein may of course include many other logical, programmatic, and physical components, of which those shown in the accompanying figures are merely examples that are related to the discussion herein.

Other architectures may be used to implement the described functionality, and are intended to be within the scope of this disclosure. Furthermore, although specific distributions of responsibilities are defined above for purposes of discussion, the various functions and responsibilities might be distributed and divided in different ways, depending on circumstances.

### Example One

A method comprising: providing a non-cache-aware synchronization primitive (e.g., a lock, a rundown reference, a spinlock, a mutex, etc.) in a multiprocessor computer system having a shared memory; determining a level of cache-line contention resulting from operations (e.g., interlocked operations) on the non-cache-aware synchronization primitive; and in response to determining that the level of cache-line contention meets or exceeds a threshold, changing the non-cache-aware synchronization primitive to a cache-aware synchronization primitive that allocates individual cache lines of the shared memory to respective processors of the multiprocessor computer system.

### Example Two

The method of Example One, wherein the determining the level of cache-line contention comprises measuring a parameter during performance of the operations, the parameter including at least one of a cycle count, a number of InterlockedCompareExchange retries, or a frequency of the operations.

### Example Three

The method of any of the previous examples, alone or in combination, wherein the determining the level of cache-line contention comprises: collecting statistics for the non-cache-aware synchronization primitive, the statistics comprising measurements of a parameter (e.g., a cycle count, a number of InterlockedCompareExchange retries, or a frequency of the operations) that are taken during performance of the operations on the non-cache-aware synchronization primitive over a period of time; and calculating a statistical value (e.g., an average, median, mode, minimum, maximum, etc.) of the parameter based at least in part on the collected statistics, wherein the determining that the level of cache-line contention meets or exceeds the threshold comprises comparing the statistical value of the parameter to a baseline value of the parameter that represents a value of the parameter when the operations are performed without the cache-line contention.

### Example Four

The method of any of the previous examples, alone or in combination, wherein the collecting the statistics comprises: determining whether a context switch has occurred during individual ones of the measurements; and if the context switch has occurred during a particular measurement, discarding the particular measurement from the collected statistics.

### Example Five

The method of any of the previous examples, alone or in combination, wherein the measurements were taken from a sampled subset of the operations performed over the period of time.

### Example Six

The method of any of the previous examples, alone or in combination, wherein the baseline value of the parameter is at least one of: (i) computed by measuring the parameter during performance of one or more of the operations at boot time of the multiprocessor computer system, (ii) statically hard-coded within the multiprocessor computer system; or (iii) configured by an administrator of the multiprocessor computer system.

### Example Seven

The method of any of the previous examples, alone or in combination, wherein the statistics further comprise: a number of exclusive acquires or a number of exclusive releases of the non-cache-aware synchronization primitive over the period of time; and a number of shared acquires or a number of shared releases of the non-cache-aware synchronization primitive over the period of time, wherein the expanding is conditioned on a ratio of the number of exclusive acquires or releases to the number of shared acquires or releases being below a threshold ratio.

### Example Eight

The method of any of the previous examples, alone or in combination, wherein the non-cache-aware synchronization primitive is a lock.

### Example Nine

The method of any of the previous examples, alone or in combination, wherein the operations comprise interlocked operations associated with acquires or releases of the non-cache-aware synchronization primitive.

### Example Ten

The method of any of the previous examples, alone or in combination, wherein the expanding comprises: setting a transitioning state (e.g., setting a transition bit) of the non-cache-aware synchronization primitive; allocating the individual cache lines of the shared memory to the respective processors of the multiprocessor computer system; and changing the transitioning state to an expansion state (e.g., setting an expansion bit) of the non-cache-aware synchronization primitive.

### Example Eleven

The method of any of the previous examples, alone or in combination, wherein the setting the transitioning state occurs while at least one thread is holding the non-cache-aware synchronization primitive based on a shared acquire from the at least one thread.

### Example Twelve

A computer-readable memory executable by one or more of a plurality of processors of a multiprocessor system, the computer-readable memory storing a data structure of a non-cache-aware synchronization primitive and computer-executable instructions that, when executed by at least one of the one or more processors of the multiprocessor system, perform the following acts: determining a level of cache-line contention resulting from operations on the non-cache-aware synchronization primitive; and in response to determining that the level of cache-line contention meets or exceeds a threshold, changing the non-cache-aware synchronization primitive to a cache-aware synchronization primitive that allocates individual cache lines of the shared memory to respective processors of the multiprocessor computer system.

### Example Thirteen

The computer-readable memory of Example Twelve, the acts further comprising: registering the cache-aware synchronization primitive in a shared registry of expanded synchronization primitives; contracting the cache-aware synchronization primitive to revert to the non-cache-aware synchronization primitive after a period of time has lapsed since the expanding; and removing the cache-aware synchronization primitive from the shared registry.

### Example Fourteen

The computer-readable memory of any of the previous examples, alone or in combination, the acts further comprising contracting the cache-aware synchronization primitive to revert to the non-cache-aware synchronization primitive after a period of time has lapsed since the expanding.

### Example Fifteen

The computer-readable memory of any of the previous examples, alone or in combination, the acts further comprising waiting to free the shared memory of the allocated cache lines until there are no threads holding the cache-aware synchronization primitive.

### Example Sixteen

The computer-readable memory of any of the previous examples, alone or in combination, the acts further comprising: performing an operating system interrupt on a plurality of processors of the multiprocessor computer system; and checking whether there are any threads holding the cache-aware synchronization primitive.

### Example Seventeen

The computer-readable memory of any of the previous examples, alone or in combination, the acts further comprising: determining whether any threads are pending acquisition of an allocated cache line of the cache-aware synchronization primitive, the determining being based at least in part on (i) checking a list of in-progress lock acquires for individual ones of the threads, or (ii) checking whether a thread-local bit is set for individual ones of the threads; and refraining from contracting if the determining indicates that there is at least one thread that is about to acquire the allocated cache line of the cache-aware synchronization primitive.

### Example Eighteen

The computer-readable memory of any of the previous examples, alone or in combination, wherein the contracting is further conditioned on a number of cache-aware synchronization primitives on the multiprocessor computer system exceeding a threshold number of cache-aware synchronization primitives.

### Example Nineteen

The computer-readable memory of any of the previous examples, alone or in combination, the acts further comprising, before the contracting, collecting statistics for the cache-aware synchronization primitive, the statistics comprising: a number of exclusive acquires or a number of exclusive releases of the cache-aware synchronization primitive over the period of time; and a number of shared acquires or a number of shared releases of the cache-aware synchronization primitive over the period of time, wherein the contracting is further conditioned on a ratio of the number of shared acquires or releases to the number of exclusive acquires or releases being below a threshold ratio.

### Example Twenty

The computer-readable memory of any of the previous examples, alone or in combination, wherein the number of shared acquires or shared releases of the cache-aware synchronization primitive is maintained per cache line of the cache-aware synchronization primitive.

### Example Twenty-One

The computer-readable memory of any of the previous examples, alone or in combination, the acts further comprising, before the contracting, collecting statistics for the cache-aware synchronization primitive, the statistics comprising a number of exclusive acquires or a number of exclusive releases of the cache-aware synchronization primitive over the period of time, and wherein the contracting is further conditioned on the number of exclusive acquires or releases being above a threshold number of exclusive acquires or releases.

### Example Twenty-Two

The computer-readable memory of any of the previous examples, alone or in combination, the acts further comprising, before the contracting: collecting pre-expansion statistics for a rate of shared acquires or a rate of shared releases of the non-cache-aware synchronization primitive; and collecting post-expansion statistics for the rate of shared acquires or the rate of shared releases of the cache-aware synchronization primitive, wherein the contracting is further conditioned on the post-expansion statistics indicating a lower rate of shared acquires or shared releases of the cache-aware synchronization primitive as compared to the rate of shared acquires or shared releases in the pre-expansion statistics.

### Example Twenty-Three

The computer-readable memory of any of the previous examples, alone or in combination, the acts further comprising, before the contracting, pinning the cache-aware synchronization primitive to a location in the shared memory if the cache-aware synchronization primitive is a paged synchronization primitive.

### Example Twenty-Four

A multiprocessor system comprising: a plurality of processors; and a shared memory comprising a plurality of cache lines accessible by the plurality of processors, the shared memory storing an operating system and a data structure of a non-cache-aware synchronization primitive, wherein the operating system includes logic to perform the following acts: determine a level of cache-line contention resulting from operations on the non-cache-aware synchronization primitive; and in response to determining that the level of cache-line contention meets or exceeds a threshold, change the non-cache-aware synchronization primitive to a cache-aware synchronization primitive that allocates individual ones of the cache lines of the shared memory to respective processors of the plurality of processors.

### Example Twenty-Five

The multiprocessor system of Example Twenty-Five, wherein determining the level of cache-line contention comprises measuring a parameter during performance of the operations, the parameter including at least one of a cycle count, a number of InterlockedCompareExchange retries, or a frequency of the operations.

### Example Twenty-Six

The multiprocessor system of any of the previous examples, alone or in combination, wherein the logic is further configured to scale down the measured parameter using a scaling factor, and wherein the data structure of the non-cache-aware synchronization primitive is configured to store the scaled down parameter.

### Example Twenty-Seven

The multiprocessor system of any of the previous examples, alone or in combination, wherein the scaled statistics are stored as a data value that is no greater than about 32 bits.

### Example Twenty-Eight

A multiprocessor system comprising: means for executing computer-executable instructions (e.g., processors, including, for example, hardware processors such as central processing units (CPUs), system on chip (SoC), etc.); and a means for storing computer-executable instructions (e.g., memory, computer readable storage media such as RAM, ROM, EEPROM, flash memory, etc.), the means for storing comprising a plurality of cache lines accessible by the means for executing computer-executable instructions, and storing an operating system and a data structure of a non-cache-aware synchronization primitive, wherein the operating system includes logic to perform the following acts: determine a level of cache-line contention resulting from operations on the non-cache-aware synchronization primitive; and in response to determining that the level of cache-line contention meets or exceeds a threshold, change the non-cache-aware synchronization primitive to a cache-aware synchronization primitive that allocates individual ones of the cache lines of the means for storing computer-executable instructions to respective ones of the means for executing computer-executable instructions.

### CONCLUSION

In closing, although the various embodiments have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method comprising:
providing a non-cache-aware synchronization primitive in a multiprocessor computer system having a shared memory;
determining a level of cache-line contention resulting from operations on the non-cache-aware synchronization primitive; and
in response to determining that the level of cache-line contention meets or exceeds a threshold, changing the non-cache-aware synchronization primitive to a cache-aware synchronization primitive that allocates individual cache lines of the shared memory to respective processors of the multiprocessor computer system.

2. The method of claim 1, wherein the determining the level of cache-line contention comprises measuring a parameter during performance of the operations, the parameter including at least one of a cycle count, a number of InterlockedCompareExchange retries, or a frequency of the operations.

3. The method of claim 1, wherein the determining the level of cache-line contention comprises:
collecting statistics for the non-cache-aware synchronization primitive, the statistics comprising measurements of a parameter that are taken during performance of the operations on the non-cache-aware synchronization primitive over a period of time; and
calculating a statistical value of the parameter based at least in part on the collected statistics, and
wherein the determining that the level of cache-line contention meets or exceeds the threshold comprises comparing the statistical value of the parameter to a baseline value of the parameter that represents a value of the parameter when the operations are performed without the cache-line contention.

4. The method of claim 3, wherein the baseline value of the parameter is at least one of: (i) computed by measuring the parameter during performance of one or more of the operations at boot time of the multiprocessor computer system, (ii) statically hard-coded within the multiprocessor computer system; or (iii) configured by an administrator of the multiprocessor computer system.

5. The method of claim 3, wherein the statistics further comprise:
a number of exclusive acquires or a number of exclusive releases of the non-cache-aware synchronization primitive over the period of time; and
a number of shared acquires or a number of shared releases of the non-cache-aware synchronization primitive over the period of time,
wherein the expanding is conditioned on a ratio of the number of exclusive acquires or releases to the number of shared acquires or releases being below a threshold ratio.

6. The method of claim 1, wherein the non-cache-aware synchronization primitive is a lock.

7. The method of claim 1, wherein the operations comprise interlocked operations associated with acquires or releases of the non-cache-aware synchronization primitive.

8. The method of claim 1, wherein the expanding comprises:
setting a transitioning state of the non-cache-aware synchronization primitive;
allocating the individual cache lines of the shared memory to the respective processors of the multiprocessor computer system; and
changing the transitioning state to an expansion state of the non-cache-aware synchronization primitive.

9. The method of claim 8, wherein the setting the transitioning state occurs while at least one thread is holding the non-cache-aware synchronization primitive based on a shared acquire from the at least one thread.

10. A computer-readable memory executable by one or more of a plurality of processors of a multiprocessor system, the computer-readable memory storing a data structure of a non-cache-aware synchronization primitive and computer-executable instructions that, when executed by at least one of the one or more processors of the multiprocessor system, perform the following acts:
determining a level of cache-line contention resulting from operations on the non-cache-aware synchronization primitive; and
in response to determining that the level of cache-line contention meets or exceeds a threshold, changing the non-cache-aware synchronization primitive to a cache-aware synchronization primitive that allocates individual cache lines of the shared memory to respective processors of the multiprocessor computer system.

11. The computer-readable memory of claim 10, the acts further comprising contracting the cache-aware synchronization primitive to revert to the non-cache-aware synchronization primitive after a period of time has lapsed since the expanding.

12. The computer-readable memory of claim 11, the acts further comprising waiting to free the shared memory of the allocated cache lines until there are no threads holding the cache-aware synchronization primitive.

13. The computer-readable memory of claim 12, the acts further comprising:
performing an operating system interrupt on a plurality of processors of the multiprocessor computer system; and
checking whether there are any threads holding the cache-aware synchronization primitive.

14. The computer-readable memory of claim 11, the acts further comprising:
determining whether any threads are pending acquisition of an allocated cache line of the cache-aware synchronization primitive, the determining being based at least in part on (i) checking a list of in-progress lock acquires for individual ones of the threads, or (ii) checking whether a thread-local bit is set for individual ones of the threads; and
refraining from contracting if the determining indicates that there is at least one thread that is about to acquire the allocated cache line of the cache-aware synchronization primitive.

15. The computer-readable memory of claim 11, wherein the contracting is further conditioned on a number of cache-aware synchronization primitives on the multiprocessor computer system exceeding a threshold number of cache-aware synchronization primitives.

16. The computer-readable memory of claim 11, the acts further comprising, before the contracting, collecting statistics for the cache-aware synchronization primitive, the statistics comprising:
a number of exclusive acquires or a number of exclusive releases of the cache-aware synchronization primitive over the period of time; and
a number of shared acquires or a number of shared releases of the cache-aware synchronization primitive over the period of time,
wherein the contracting is further conditioned on a ratio of the number of shared acquires or releases to the number of exclusive acquires or releases being below a threshold ratio.

17. The computer-readable memory of claim 16, wherein the number of shared acquires or shared releases of the cache-aware synchronization primitive is maintained per cache line of the cache-aware synchronization primitive.

18. A multiprocessor system comprising:
a plurality of processors; and
a shared memory comprising a plurality of cache lines accessible by the plurality of processors, the shared memory storing an operating system and a data structure of a non-cache-aware synchronization primitive, wherein the operating system includes logic to perform the following acts:
determine a level of cache-line contention resulting from operations on the non-cache-aware synchronization primitive; and
in response to determining that the level of cache-line contention meets or exceeds a threshold, change the non-cache-aware synchronization primitive to a cache-aware synchronization primitive that allocates individual ones of the cache lines of the shared memory to respective processors of the plurality of processors.

19. The multiprocessor system of claim 18, wherein determining the level of cache-line contention comprises measuring a parameter during performance of the operations, the parameter including at least one of a cycle count, a number of InterlockedCompareExchange retries, or a frequency of the operations.

20. The multiprocessor system of claim 19, wherein the logic is further configured to scale down the measured parameter using a scaling factor, and wherein the data structure of the non-cache-aware synchronization primitive is configured to store the scaled down parameter.
